(19) United States
(12) Patent Application Publication
(10) Pub. No.: US 2006/0174222 A1
(43) Pub. Date: Aug. 3, 2006

(54) Software system requirements specification framework and tool

(75) Inventors: Srinivas Thonse, Bangalore (IN); Nagaraja Nanjegowda Siddaramappa, Bangalore (IN); Renuka Sindhgatta, Bangalore (IN); Pasupathy Mahalingam, Chennai (IN); Sridhar Dhulipala, Bangalore (IN); Raghavan Subramanian, Trichy (IN)

Correspondence Address: KLARQUIST SPARKMAN, LLP, 121 SW SALMON STREET, SUITE 1600, PORTLAND, OR, 97204, US

(73) Assignee: Infosys Technologies Ltd.

(21) Appl. No.: 11/084,730

(22) Filed: Mar. 17, 2005

(30) Foreign Application Priority Data
Feb. 3, 2005 (IN) 93/CHE/2005

(51) Int. Cl. G06F 9/44

(52) U.S. Cl. 717/106

(57) ABSTRACT

Described herein are methods and systems for capturing functional and non-functional requirements of a software system. Both functional and non-functional requirements are captured in a framework that is easy for end users to use for participating directly at various levels of a requirements capture process. Functional aspects are desirably captured in terms of workflow notations to form a task flow model of the system, which in turn provides a desirable framework for eliciting and appropriately capturing the non-functional requirements. The task flow model updated with functional and non-functional requirements can be comprehensive and accurate enough to be used to generate test cases, to simulate usability and to generate conventional text based use cases. The requirements captured can be verified for quality of domain context to encourage re-use of domain terms.

### TECHNICAL FIELD

The present invention relates to capture of requirements of software systems. More particularly, the field relates to automated tools for capturing requirements of enterprise software applications.

### BACKGROUND

Successful design and development of any software system typically begins with the definition of requirements of the system. Requirements may be functional (e.g., what the system does) or non-functional (e.g., how well a system does). Thus, comprehensive and accurate capture of requirements are essential to a successful deign and development of software systems. Software systems related to enterprise entities generally comprise software applications that automate one or more business processes associated with the enterprise. Thus, software systems related to enterprises have the additional challenge of identifying and representing requirements in a manner that is easily understood by both the business users of the software systems, who have extensive knowledge of the business domain for which the system is intended, as well as the application developers, who have the technical knowledge for implementing the software system.

Use cases are one form of capturing software system requirements. Generally, use cases are used to document different scenarios of interactions between a user and a system, conditions for execution and any assumptions. Use cases are typically recorded as narrative text to ensure simplicity and active participation of stakeholders (e.g., end users of the software system being designed). However, in practice, oversimplification and use of natural language in such textual descriptions results in ambiguity leading to a confusing variety of interpretations of the requirements. Thus, requirements have to be continually verified and revisited by the stakeholders, which can lead to untimely calls for changes in the requirements in the later stages of software development. This leads to additional expenditures related to development resources and costs.

Several techniques have been proposed to use formal semantics in describing use cases. While the formal semantics are helpful to the technical system implementation team, they are typically too complex for business and operational users of the system. Some approaches also isolate the capture of functional (e.g., system functionality) from non-functional requirements such as, but not limited to, system metrics related to performance speed, usability and security. Hence, the development team and the business experts participating in requirements definition process do not have the complete view of the system requirements. In effect, they may not have a complete understanding of how the system performs.

### SUMMARY

Described herein are methods and systems for capturing requirements of a software system. In one aspect, the system is first represented broadly in terms of a business process model comprising one or more activities related to the system. In another aspect, the functional requirements of the system are captured in terms of a task flow model representing workflows between one or more tasks related to one or more activities of the system. In another aspect, the task flow model can be updated to comprise non-functional requirements along with the functional requirements. In yet another aspect, at least some of the non-functional requirements are desirably elicited in the context of the task flow model, which provides an easy to use framework for capturing requirements.

In a further aspect, the capture of the non-functional requirements for at least some of the tasks in a task flow model is desirably based on a classification of the tasks. For tasks classified as user tasks or interactive tasks the non-functional requirements to be captured may comprise usability and performance. In one aspect, specifying usability requirements comprises associating screens with tasks of a task flow model. In another aspect, screens associated with various tasks can be related to each other to form a screen flow. The screen flow can be used to simulate an exemplary usability scenario of the software system being designed. Performance requirements for interactive tasks desirably includes think time for estimating time for user entry of data and response time for system to accept data. In another aspect, requirements for tasks classified as a system task desirably include desired response time for the system to perform the task.

In yet another aspect, security requirements can be applied to task flow models for each activity of the system. Security requirements can be desirably derived from security requirements related to interaction of entities across between different security domains. These interaction based security requirements are synthesized with the system level requirements to derive the overall security requirements for the system.

In one other aspect, captured requirements can be verified to determine their domain context quality by evaluating the degree of use of the appropriate domain terms within the requirements specification, for instance. The foregoing and other objects, features, and advantages of embodiments disclosed herein will become more apparent from the following detailed description, which proceeds with reference to the accompanying figures. The invention includes all novel and non-obvious methods and apparatus elements disclosed herein, alone and in various combinations and sub-combinations with one another and regardless of whether anyone or more of the advantages disclosed herein are satisfied.

### BRIEF DESCRIPTION OF THE DRAWINGS

FIG. 1 is a block diagram illustrating an exemplary business process model of a proposed software system.

FIG. 2 is a block diagram illustrating an exemplary use case diagram of the business process model of FIG. 1.

FIG. 3 is a block diagram illustrating an exemplary hierarchical arrangement of detail levels for capturing requirements related to a proposed software system.

FIG. 4 is a block diagram illustrating an exemplary task flow model related to an exemplary activity of the business process model of FIG. 1 for capturing requirements of the proposed software system.

FIG. 5 is a block diagram illustrating an exemplary framework for capturing requirements based on task classifications of tasks in a task flow of a proposed software system.

FIG. 6 is a block diagram illustrating an exemplary framework for capturing usability requirements based on a task flow related to the software system.

FIG. 7 is a block diagram illustrating an exemplary framework for capturing performance requirements based on a task flow related to the proposed system.

FIG. 8 is a block diagram illustrating an exemplary task flow model depicting functional requirements of a proposed system along with non-functional requirements.

FIG. 9 is a block diagram illustrating an exemplary software development tool for capturing and processing requirements of a proposed system.

FIG. 10 is a flow diagram of an exemplary method for generating a task flow updated with non-functional requirements captured based on classification of tasks of the task flow model.

FIG. 11 is a flow diagram of an exemplary method of capturing security requirements for a proposed system based on security requirements of interaction segments related to the system and system level security requirements.

FIG. 12 is a flow diagram of an exemplary method of verifying the domain context of requirements specified for a proposed system.

FIG. 13 is a block diagram illustrating an exemplary user interface for building a business process model of a proposed system.

FIG. 14 is a block diagram illustrating an exemplary user interface for building a task flow model of a proposed system.

FIG. 15 is a block diagram illustrating an exemplary user interface for specifying screen association to specific tasks of a task flow model.

FIG. 16 is a block diagram illustrating an exemplary user interface for specifying relationships between various screens associated with various tasks in order to specify a screen flow related to a proposed system.

FIG. 17 is a block diagram illustrating an exemplary user interface for requesting to enter performance requirements for tasks of a task flow model of a proposed system.

FIG. 18 is a block diagram illustrating an exemplary user interface for specifying performance requirements for tasks of a task flow model of a proposed system.

FIG. 19 is a block diagram illustrating an exemplary user interface for requesting the generation of use cases for a proposed system.

FIG. 20 is a block diagram illustrating an exemplary user interface displaying the use cases of the system in a UML notation based on the request of FIG. 19.

FIG. 21 is a block diagram illustrating an exemplary user interface for specifying a domain for a domain verifier.

FIG. 22 is a block diagram illustrating an exemplary user interface for displaying results of a domain verification process.

FIG. 23 is a block diagram depicting a general-purpose computing device constituting an exemplary computer system for implementing the disclosed technology.

### DETAILED DESCRIPTION

### An Exemplary Overall Method for Specifying Requirements for a Software System

Active participation from the business or end users of a proposed software system in its design and development is often very important. More particularly, their participation early on in the development process is often critical for accurately and comprehensively capturing the requirements of the software system. Reducing the complexity involved in capturing the software system requirements accurately and comprehensively leads to an increase in the effective involvement of the end users early in development process.

Unified Modeling language (UML) prescribes use cases as one method of capturing requirements of a software system. Each use case related to a system desirably provides one or more scenarios regarding how the system should interact with a user or another system to achieve a specific business goal. Multiple use cases may be needed to describe the various features of a particular system. One approach to specifying use cases begins with describing business processes belonging to an enterprise and analyzing how the processes should be automated by a the proposed software system. Thus, an exemplary use case specification requires designers to ask business users about what they need from the proposed software system. These needs outline how the users propose to use the system or, in other words, what should the system be capable of doing. These needs can form a basis for use-cases.

One way to reduce complexity in the process of capturing requirements, while also increasing the details of the requirements that are captured, is to adopt workflow notations to document requirements based on use cases and to elicit additional requirements from the end users, including any non-functional requirements within the context of specifying use cases. To achieve this end, it is useful to adopt workflow notations and concepts that end users may be familiar with, that are easy to understand and, that provide for accurate capture of requirements.

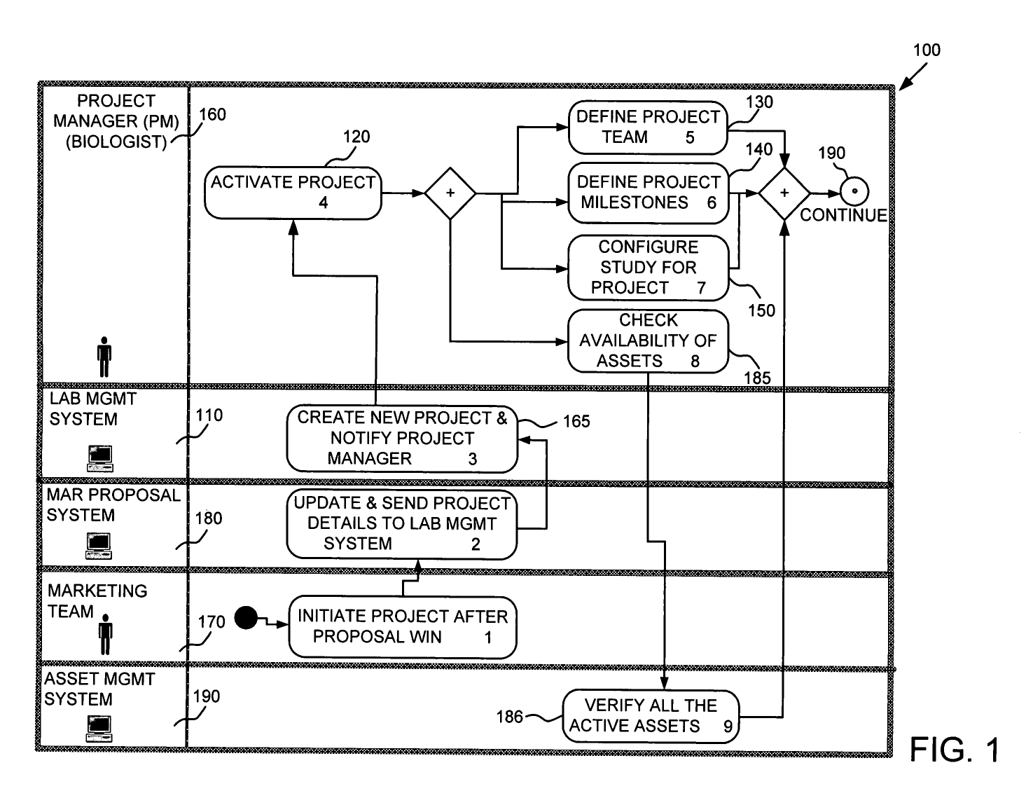

Thus, in one model of software development, the software system design begins with identifying business processes of the enterprise for automation by the proposed software system. Business processes are defined as sequences of activities undertaken by users and a system to realize business goals of the enterprise. For instance, FIG. 1 illustrates an exemplary business process model 100 related to a pharmaceutical enterprise that conducts medical tests on samples for various customers and provides reports on the samples. The laboratory (lab) management system 110 is a software system proposed for automating at least some of the activities related to creating and managing medical test projects. The exemplary activities in such an enterprise may include activating a project 120, defining a project team 130, defining project milestones 140 and configuring a study 150 (referring to a set of tests that need to be done in the lab), which are performed according to the model 100 by the project manager actor 160. The process may continue further at 190.

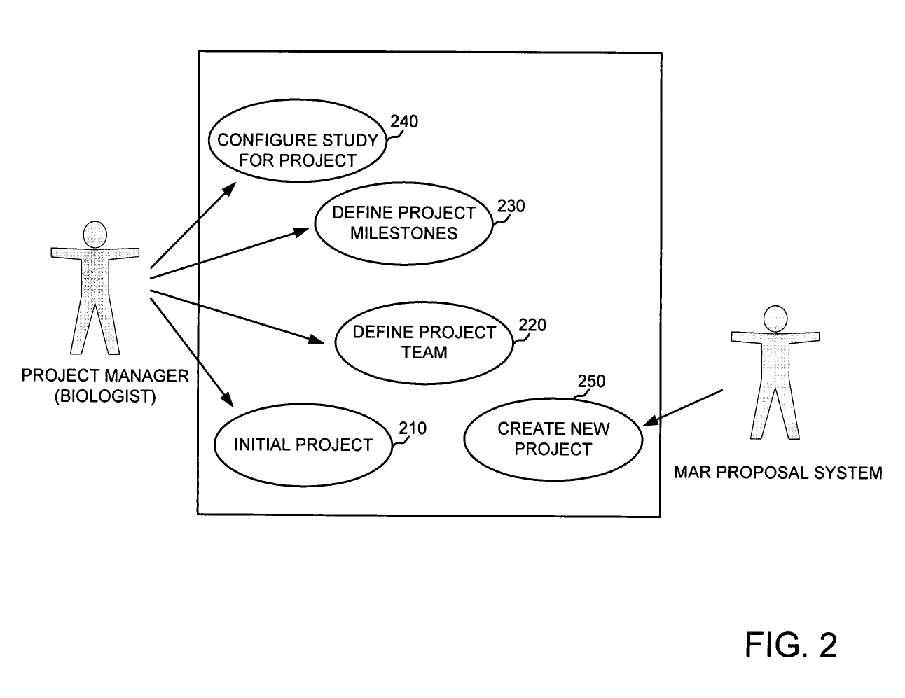

The project is created first at 165 by the marketing team actor 170 within the proposal system 180, for instance. The availability of assets 185 is verified at 186 in the Asset Management System 190. Thus, a set of use cases for the business process model 100 comprising a set of activities performed by users (e.g., Project Manager 160) or other systems (e.g., MAR Proposal System 180) on the lab management system of pharmaceutical testing enterprise may be illustrated in the Unified Modeling Language (UML) notation as shown in FIG. 2.

As shown in FIG. 1, a business process model 100 can be represented to depict workflow information between the various activities in the process being automated. The Business Process Modeling Notation (BPMN) issued by the Business Process Management Initiative may be one such workflow notation. Any other type of workflow notation form that is easily understood and familiar to business users can also be used.

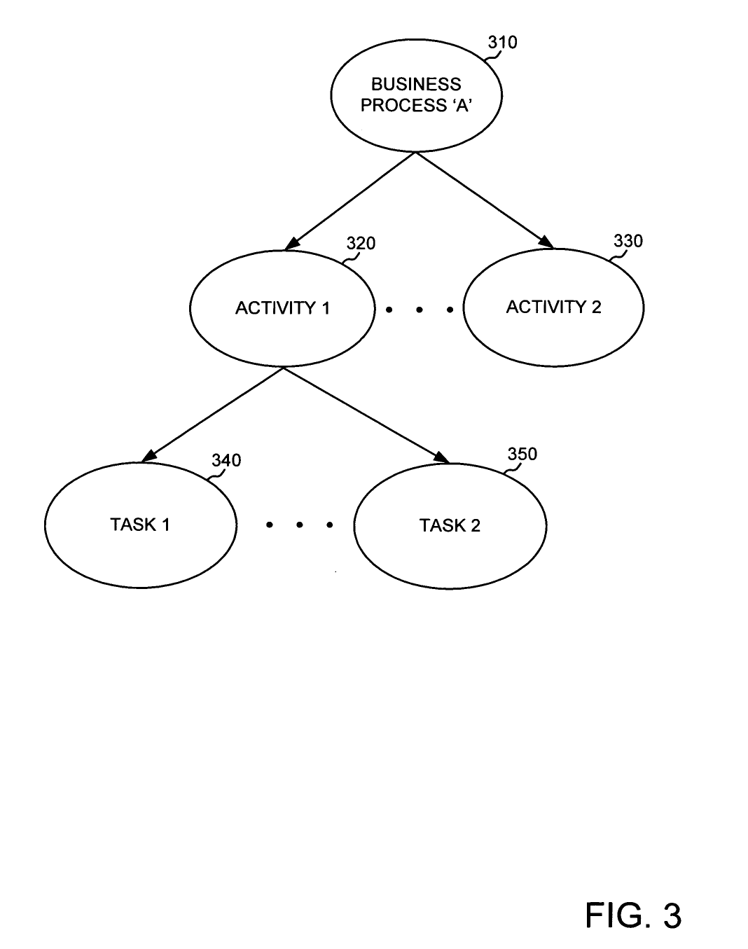

After the identification of the activities that are candidates for automation by the software system being designed (e.g., 210-250 in FIG. 2), the requirements related to flow of tasks within each activity can be documented at additional levels of detail to capture a more comprehensive collection of requirements. FIG. 3 illustrates one exemplary hierarchy of details for capturing data related requirements of a software system. One or more business processes 310 (e.g., 100 in FIG. 1) of an enterprise may be defined as a collection of one or more activities (e.g., 320-330) within the processes and each activity may be further detailed as a collection of one or more tasks (e.g., 340-350). The activities link to use cases of the system and the collection of tasks link to the flow of events of the identified use case. Requirements can be captured methodically based on the activities and tasks requirements. The requirements of the system can be specified at various levels of detail. Such requirements need not be restricted to functional details related to system functionality, but can also be related to non-functional requirements, such as various metrics related to the expected performance from the system, usability of the system, and security related requirements of the system.

### An Exemplary Task Flow Model Comprising Task Classifications for Specifying Requirements of a Software System

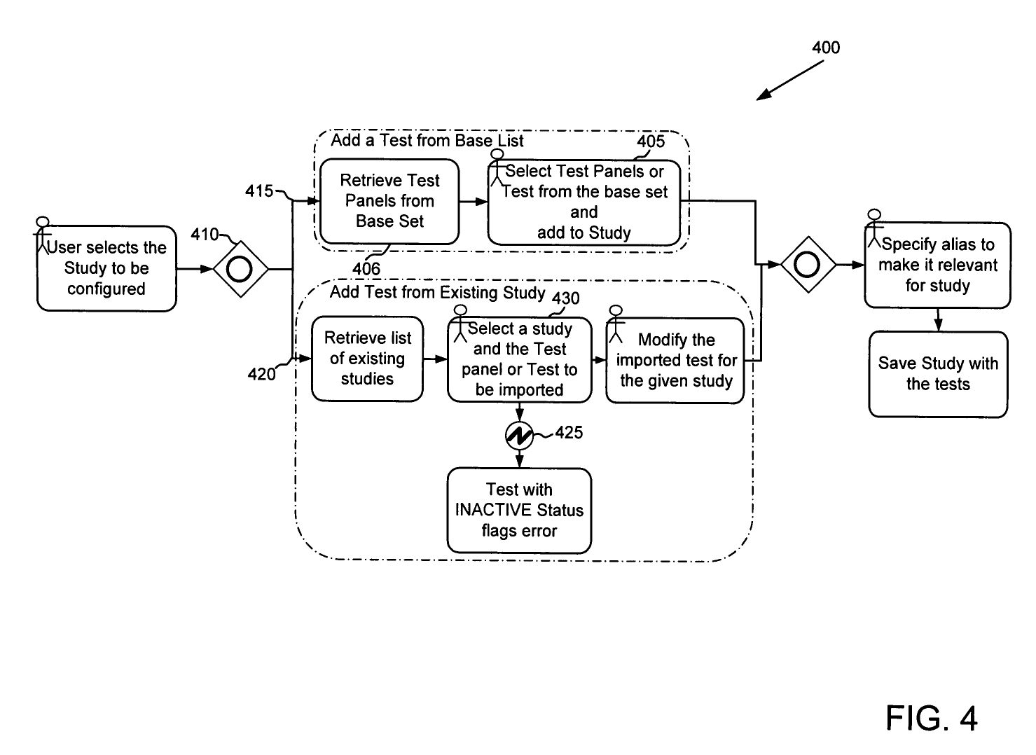

As noted above, once the various activities (e.g., 210-250) within a business process model (e.g., 100 of FIG. 1) are identified, each activity is desirably defined by adding further details comprising a set of tasks associated with the activity. The workflow notation (e.g., BPMN), is used at the task definition level to add structure and clarity to the requirements capture process. Such a representation of tasks using workflow notations is referred to herein as a task flow model. FIG. 4 illustrates one such example of a task flow model 400 for representing a flow of tasks within an activity of the lab management system 110 of FIG. 1, which represents the functional requirements of the lab management system. The task flow model 400 is an exemplary representation of an exemplary flow of tasks related to the configure study activity 150 of the business process model 100 of FIG. 1. Other task flow models are possible for other activities within the business process model 100, for instance.

The task flow model 400 depicts the user and system interaction where there is a constant transfer of the control between the user and the system. Thus, each task can be classified as an interactive task involving a user's interaction with the system or a system task involving execution of some functionality by the system. For example, entering a form with user details is a task performed by the user and can be classified as an interactive task. The validation of whether appropriate user details were entered by the user is classified as a system task. Hence, the workflow notation for indicating the task flow is desirably extended to depict the classification of tasks as interactive or system tasks.

Classification of tasks in this manner enables identification of the system and user responsibilities for executing a use case scenario and it provides structure to the end user for defining the requirements of the system. The following Table 1 describes an exemplary notation for classification of tasks as interactive tasks or system tasks.

TABLE 1

| Task Type | Notation |
|---|---|
| Interactive Task is a task where the user is involved in interacting with the system. | 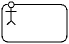 |
| System Task is a task where the system performs the task. | 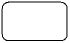 |

FIG. 4 illustrates the task flow model 400 for the configure study activity 150 of FIG. 1. At 405, the select test panel task is classified as an interactive task, whereas the retrieve test panel task 406 is classified as a system task. Exemplary workflow notations are provided to depict flow of tasks and their relationships. For instance, a BPMN workflow notation at 410 depicts an inclusive OR scenario where one or both parallel paths 415 and 420 can be realized. An exception is identified using the exception event notation at 425. Such a standardized graphical representation of task flow provides for a standard interpretation of use case flow of events related to software design. More importantly, it provides a framework for capturing different requirements for tasks based on their task classification, which helps in eliciting the appropriate non-functional requirements for the system. This is particularly helpful for users who themselves may not be computer programmers or are unfamiliar with software design and development methods. Thus, graphical symbols with defined meanings are desirably used in task flow models.

### An Exemplary Framework for Defining Requirements Based on Task Classification

In practice, the requirements phase of enterprise application development includes understanding the functional and non-functional requirements. For enterprise application, the critical non-functional requirements typically comprise reliability, performance, usability and security. The Software Specification Standard No. 830 promulgated by the Institute of Electronics and Electrical Engineers (IEEE) defines at least some such non-functional requirements. Using the business process models and task flow models to capture non-functional requirements along with the functional requirements allows an end user to discover inefficiencies due to bad user interface design, security issues, and bad performance levels early on in the software life cycle process. Also, based on such early feedback, the requirements can be adjusted by the end users themselves within the context of building a task flow model.

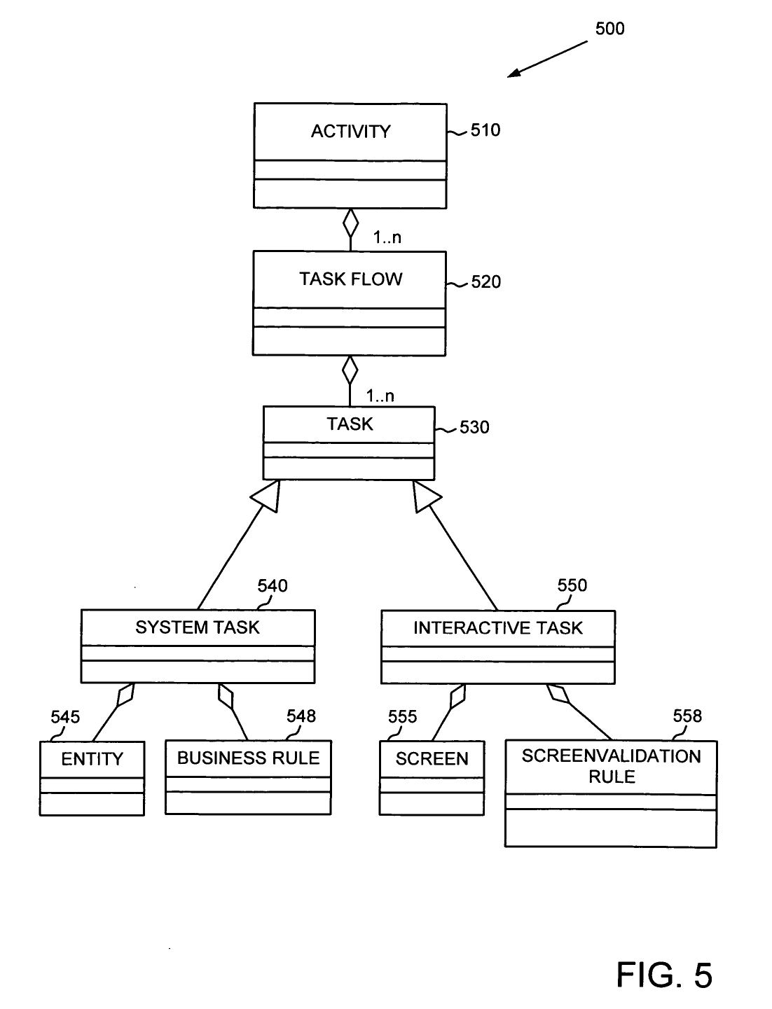

FIG. 5 shows an exemplary meta-model or framework 500 for capture of exemplary non-functional requirements based on task classification. A use case corresponding to an activity 510 can be represented as a task flow model which comprises one or more task flows 520. For instance, such flows may include task flows representing a basic flow, one or more alternate flows and one or more sub-flows. A basic task flow comprises the main path of flow of tasks that is typically done by a user. An alternate task flow comprises one or more alternate paths (e.g., 425 in FIG. 4) that a user is capable of taking while executing a particular activity in the business process. A sub-flow refers to a flow of tasks whereby an actor diverts from a main flow or one of the alternate flows and, after traversing a set of tasks in the sub-flow once again returns to the main task flow, for instance.

Each task flow (e.g., 520) in turn desirably consists of one of more tasks (e.g., 530) performed in a sequential or parallel manner, which can be indicated by standard workflow notations (e.g., BPMN). Requirements for interactive tasks 550 desirably comprise a task's association to one or more screens 555 through which the user interacts. The requirements for the interactive tasks 550 desirably also comprise screen validation rules 558 which, for instance, are rules that enable validation of input entered by a user. For instance, if a user is asked to enter his or her age as part of an interactive task, one rule may be that the value entered in the age field is verified to be of an integer field. Selected fields in a screen may also be defined in a rule as required fields. The screen related information may be available via a user interface framework being developed for the software system in question.

A task classified as a system task 540 is desirably associated with domain entities (e.g., 545) being created, updated, validated, processed, or otherwise affected by the system task. For instance, a study entity or test entity may be examples of two domain entities related to the laboratory management system 110 in FIG. 1. Domain based entities common to all tasks related to the domain of the business process can be defined as domain concepts, which can then be applied to the task flow model with requirements specified therewith to verify whether the requirements specified there within the task flow model follow the domain concepts. Thus, for example, domain concepts can comprise any expert knowledge general to all entities of the particular domain that can be re-used throughout the system to ensure, among other things, consistency, uniformity and conformance. Business rules (e.g., 548) are one class of requirements that can be specified in accordance with domain concepts. Business rules may comprise any rule or restriction related to the requirements definition based in part on what is or is not acceptable to the enterprise. Thus, for example, a software system being designed to address or automate business processes related to the enterprise would be required to operate within such rules. For instance, one business rule that might apply to the laboratory management is that only active studies can be selected at the select study task 430. Such rule s can be used in conjunction with exception flows such as at 425.

Business rules specific to a task, but not generally shared by other tasks related to the domain entity, can also be specified. Such business rules (e.g., 548) relevant for processing or validating the task are also desirably specified as a requirement related to the system task. The exemplary hierarchy 500 is used as described below in further detail to provide a framework for defining requirements of a system.

### An Exemplary Method for Capturing Usability Requirements Using a Task Flow Model

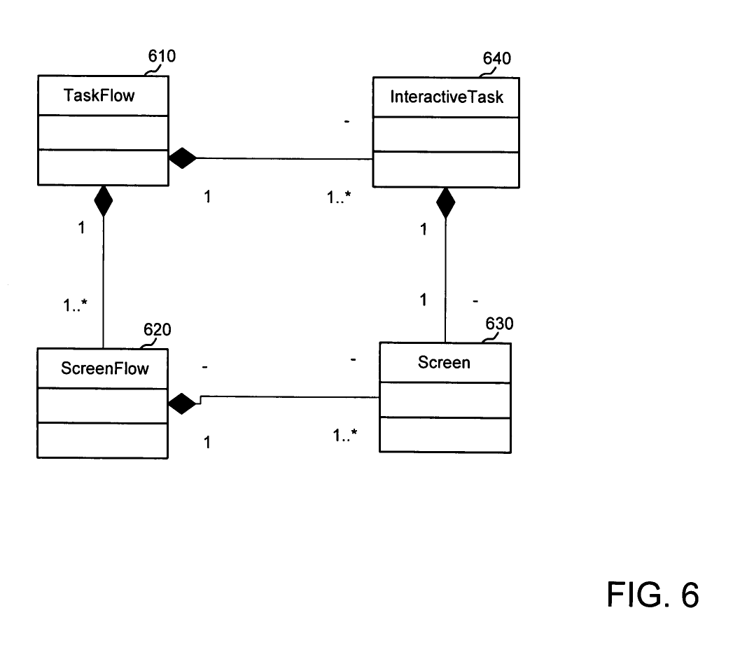

Usability in an application is primarily decided by the ease of information exchange between a user and software system. Requirements related to system usability are desirably captured by associating screens with each interactive task. The usability of a system can be verified by navigating through all the screens associated with the interactive tasks in the task flow. A screen flow is desirably created by associating various screens in terms of relationships that captures how a user might navigate the set of screens. A given task flow can have multiple screen flows depending on the various decisions gateways involved. For example, a login screen could lead to the home page or an error display page depending on the validity of the details entered. FIG. 6 illustrates exemplary details of the concepts of usability requirements capture. A task flow model 610 has one or more screen flows 620. A screen 630 is associated to a task classified as an interactive task 640. A central repository of screens would enable re-use of screens across multiple use cases and task flows.

### An Exemplary Method for Capturing System Performance Requirements Using a Task Flow Model

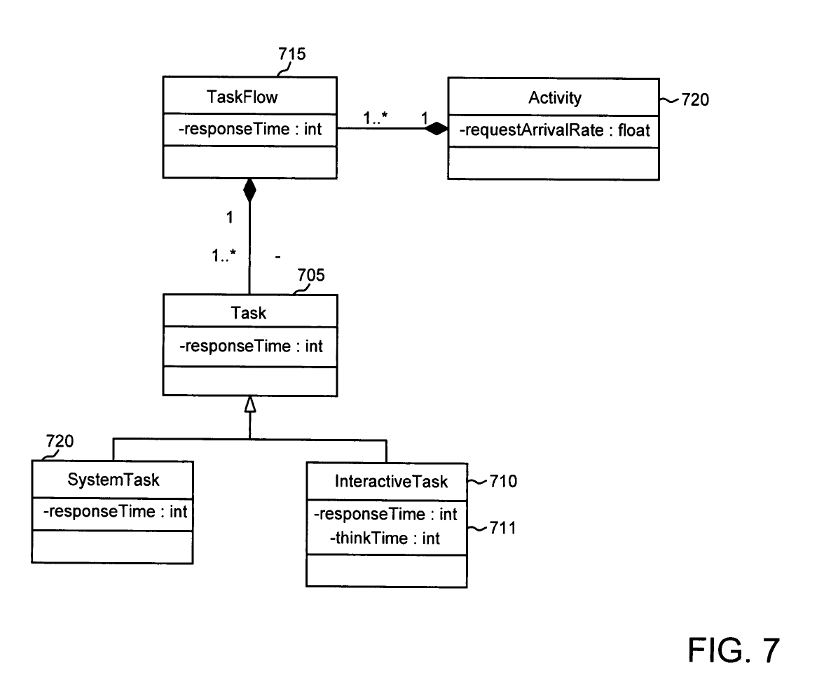

The end users can also desirably specify performance related requirements at the task flow level. Exemplary performance requirements include the expected workload on the various functions of the system and the number of users expected to use the system at any given time. In one example, the workload may be specified in terms of an expected rate of requests of service from a system. Services desirably relate to activities which comprise tasks related to the system (e.g., as in FIG. 3). Performance requirements can also include the response time expected from the system for executing various activities. One model for capturing performance related attributes is depicted in FIG. 7.

For each task 705 related to a task flow of a system, whether it happens to be an interactive task 710 or a system task 720, an expected response time or service time is desirably captured. The sum of response times of all the tasks (e.g., 705) in a task flow (e.g., 715) provides the response time of an activity 720 executing a certain set of tasks in a particular one of the task flows (e.g., 715). The expected workload on the system may be specified according to this model as an expected rate at which requests are received for the system to perform a selected activity, such as at 720. For interactive tasks such as 710, a think time requirement 711 is desirably captured. The think time represents an estimate of a minimum amount of time a potential system user spends entering and reading information on a screen associated with the task. The think time may be estimated by an expert in end user behavior.

### An Exemplary Task Flow Model Updated With Exemplary Non-Functional Requirements Data

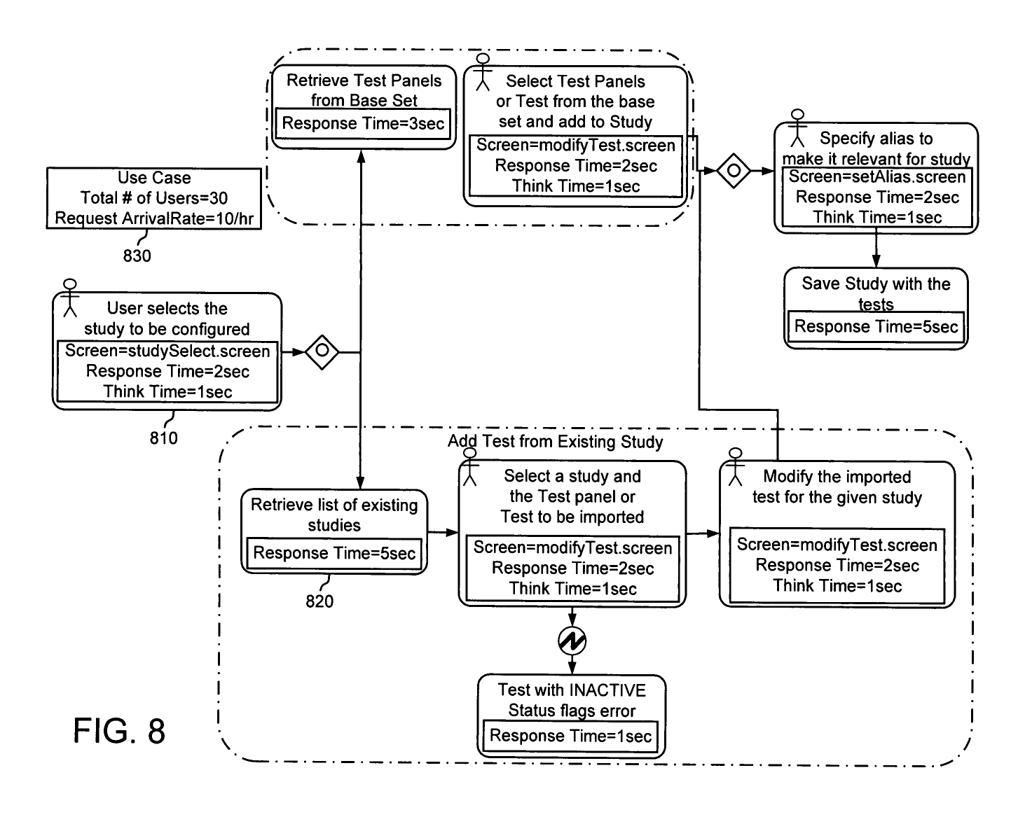

Once the requirements data including non-functional requirements are specified, an updated task flow model can be generated with the newly added requirements annotating the functional requirements model to more accurately and comprehensively describe the system requirements. FIG. 8 illustrates the example task flow model depicting not only the functional flow of tasks for representing functional requirements, but also the non-functional requirements including such requirements, as described above, related to usability and performance. Each of the interactive tasks (e.g., 810) are shown updated with requirements related to a screen, response time and think time, whereas requirements for system tasks (e.g., 820) are specified in terms of response time. The overall requirements for the specific set of task flows associated with the activity include total number of users and rate of requests for services (also referred to as requests arrival rate) at 830.

### Exemplary Methods of Using Domain Concepts and Business Rules With Ontology for Specifying Requirements of a Software System

Business rules and the domain concepts are typically important attributes of a usecase. The business rules may range, for example, from user interface validation rules to a complex condition-action rules that affect software system functionality. Ontology is a key mechanism of formalizing domain concepts and is useful in capturing and detailing the domain. Ontology is seen as a technology for managing, sharing, and re-using knowledge of applications in enterprises. Thus, Ontology is a formal mechanism of collecting and using knowledge regarding enterprises that can be re-used in similar contexts. For instance, while designing a software system solution related to a healthcare industry, it is beneficial to have access to domain knowledge developed regarding the health industry. Such knowledge will allow the system to be designed in conformance with various norms, requirements, and rules common to the industry. Providing such formalism using Ontology to capture the knowledge will result in accuracy and re-use. There are a number of different languages that may be used to specify Ontology. They may be broadly classified as frame based languages and web based Ontology specification languages. Frame based languages are more intuitive and easy to use. The Protege Ontology Editor by Stanford University of Palo Alto, Calif. is one such widely used frame based Ontology editor. An Ontology editor enables the capture of detailed domain concepts which are helpful for specifying requirements of a system. For instance, in the exemplary lab management system, the domain concepts that may be defined are for the Study and Test entities. A detailed domain model is defined in the analysis phase where the domain expert elaborates on the domain concepts related to these entities. However, building Ontology during a requirements phase helps in refining the system design and the domain concepts.

The definition of a domain concept desirably comprises the attributes detailing the type, cardinality, constraints, range and allowed values of data types that are processed, entered, and otherwise manipulated by the system. A common Ontology can be shared across the team that is describing requirements so that consistency and conformance can be instituted. Also, the Ontology and related domain concepts often become more refined as more requirements using common concepts are elicited. Detailing the domain concepts including data types and defining their constraints helps the process of identifying exceptions and invalid user inputs of values in screens, for instance.

### Exemplary Methods for Specifying Security Requirements Related to a Software System

Security requirements may be classified in the following exemplary manner:
Network level security (relating to securing the routers and the network, for instance).
Operating system level security (relating to securing the operating system on which a software application is run), by hardening the operating system (e.g., turning off irrelevant services) and installing the latest anti-virus software, for instance.
Application level security, which relates to building and deploying secure applications.
Process level security which relates to devising processes which are resilient to social engineering attacks (e.g., attacks that use human deceit).

Application level security requirements may be driven by many individual systems comprising a set of applications servicing a particular enterprise. Thus, security requirements of the individual systems may be influenced by not only the general security functional requirements that specify how sessions are managed and user data is protected, for instance, but also the interaction security requirements that specify how interacting parties are identified and authenticated, for instance.

Interaction security requirements are security requirements that are desirably defined in the context of an interaction between any two security entities. Security entities may be classified as belonging to different security domains, while interactions spanning multiple security domains can have various security requirements. Security entities may be personas (users) or systems, for instance. Even the exchange of information between two different applications within an enterprise can have security requirements. For instance, it is possible that different levels of security are required for an application that interacts with all employees of an enterprise, as opposed to applications dealing with human resources that may require higher levels of security. Crossing of a security domain boundary may occur due to interaction between a user and a system, and between two different systems, for instance. A collaboration diagram can be created (e.g., by a Business Analyst) to identify the various interactions across security domain boundaries between various security entities participating in a business process. Each segment then is representative of the interactions between different security entities. The security requirements then can be captured for the relevant interactions.

One exemplary set of interaction based security requirements can be further detailed as follows:
Identification—How does one security entity identify another?
Authentication—How does one security entity authenticate another? This may involve client side authentication and server-side authentication in a client-server environment.
Confidentiality—How do the security entities prevent unauthorized disclosure of trusted data?
Integrity—How do the two security entities prevent unauthorized modification of data?
Accountability—How do the two security entities hold each other accountable for their actions, in case of dispute?

The above requirements can be specified as security requirements for different pairs of segments in the collaboration model. However, an exemplary relationship between two security entities is directional in nature. For instance, the interaction security requirements for a client-server interaction need not be identical when the roles of the security entities are reversed.

Once a business process model of a system is further detailed in terms of a set of activities, the activities can be traced to actors belonging to interaction segments in the collaboration model. Based on the relationship between the participating actors and the respective segments to which they belong to, the security requirements for the use cases at the activity level can be determined and applied.

In addition to security requirements based on interaction related to the software application being designed. There may be general requirements at a system level defined for all applications in an enterprise, for instance. These too are desirably captured and consolidated with interaction security requirements to better ensure there is agreement between security requirements derived at the interaction segment level and the general security requirements at the system level. One exemplary set of general system level security requirements for a system may be listed as follows:
Session management—Requirements related to types of session logout (e.g., inactivity logout, and explicit logout).
Storage data protection—Requirements related to the protection of the confidentiality and integrity of stored data (as opposed to transit data, for instance).
Availability and failing securely—Requirements related to the ability to identify and thwart Denial-Of-service attacks as well as failure scenarios and the corresponding secure failure conditions.
Logging and auditing—Requirements related to log events.

Thus, a security model for an application desirably comprises one or more of the interaction security requirements and the general system level security requirements.

### An Exemplary Software Development Tool for Specifying Functional and Non-Functional Requirements of a Software System

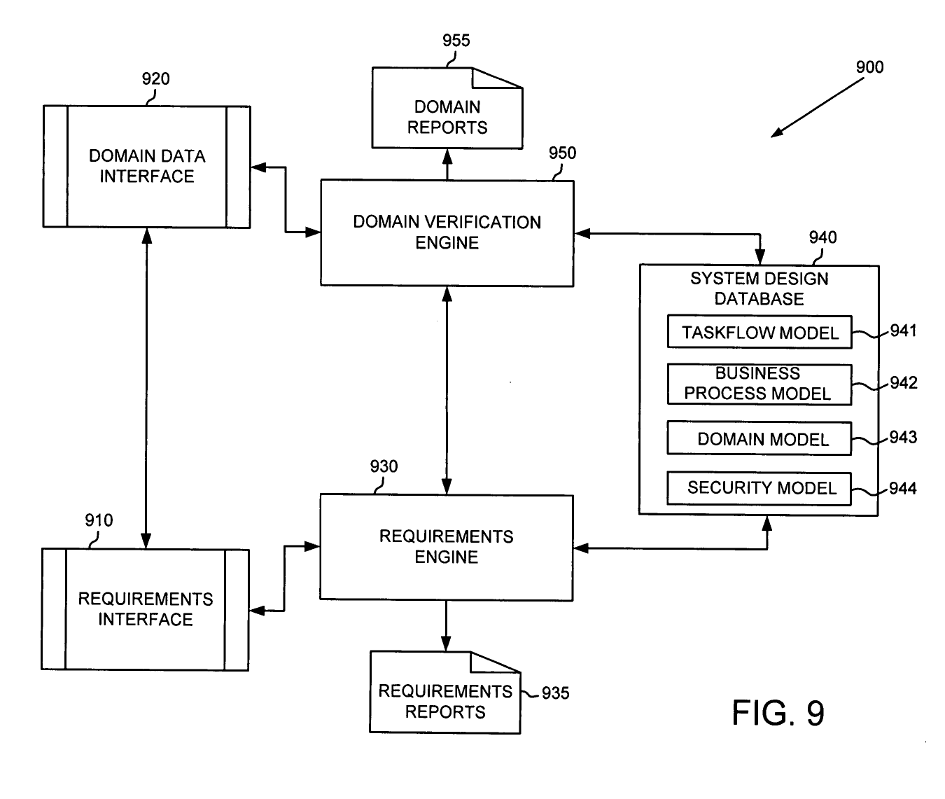

FIG. 9 illustrates a software development tool 900 that uses the framework described above for capturing system requirements including functional and non-functional requirements. The tool 900 desirably comprises a requirements user interface 910. The exemplary user interface 910 may comprise one or more screens that a user of the tool may use to specify requirements data (e.g., functional and non-functional) to the rest of the tool 900. Exemplary embodiments of the various screens of the interface 910 are described in further detail below. The software tool 900 also desirably comprises a requirements engine 930, which is capable of receiving requirements data from the interface 910, a business process level model 942 of the system being designed, a task flow model capturing at least some non-functional requirements. (e.g., usability and performance) a security model 944, and domain entity data comprised in a domain model 943 including domain concepts related to various tasks and activities of the system under design (e.g., suggested business rules for the domain). Based on at least some of the exemplary requirements data, the requirements engine 930 generates requirements related reports 935 comprising use cases, use case details, and screen design, for instance. Requirements related reports 935 may be a compilation of requirements data updated by the user of the tool 900 and stored in the context of the task flow model 941. Thus, for example, reports 935 can be generated that compile information related to functionality, usability, performance, and security attributes of the finished software design.

The task flow model 941 updated with requirements can be used in other ways. For instance, the updated requirements may also be used to generate test cases for testing the software system functionality. Also, since usability requirements may comprise screen flows, a simulation of a user's navigation through a set of screens associated with a set of tasks in the task flow can be implemented.

The illustrative software development tool 900 also comprises a domain data interface 920 capable of interacting with a domain expert for capturing domain Ontology related information for updating the domain model 943 in the system design database 940. The domain Ontology information in the domain model 943 can be applied to the requirements specified in the context of the task flow model 941 to verify the quality of the requirements. For instance, the quality of the domain context of the requirements specified in a task flow model 941 can be based on the frequency of occurrence of selected domain terms within the requirements specification.

In one embodiment, the verification of the domain context is implemented by a domain verification engine 950, which also facilitates the entry of data related to domain Ontology via the domain interface 920 to update the domain model 943 stored in the system design database 940. These functionalities can be implemented separately as well. Also, the domain verification engine 950 can be programmed to have the additional capability of providing hints to the user of the tool 900 while he or she is entering requirements data so that appropriate terms and rules are used in the requirements specification to begin with.

Once the quality of the domain context of selected requirements is verified, domain reports 955 are desirably generated. The domain reports 955 can serve as feedback information to the user of the tool so that he or she can make adjustments to the requirements, according to the content of the reports.

FIG. 9 illustrates one embodiment of a software tool 900. Other embodiments are possible. For instance, components of the tool 900 and the functionality attributed to each component can be rearranged in detail without departing from the principles described herein. For instance, at least some of the functionalities described herein can be further combined or further separated among various components of the tool 900 depending on the individual needs of a particular implementation.

### An Exemplary Method for Building and Updating a Task Flow Model With Functional and Non-Functional Requirements

A task flow model can be built for specifying the functional requirements of a system. Along with the functional requirements and the flow of tasks, non-functional requirements desirably can also be specified. As noted above this provides a proper framework for capturing a comprehensive set of requirements for the system and most importantly allows an end user to participate in the requirements capture process. At least some of the non-functional requirements can be specified on a task by task basis. As described above, usability and performance are two such examples of non-functional requirements. Thus, software development tool 900 of FIG. 9 desirably has a requirements engine 930 capable of capturing the usability requirements and the performance requirements along with task flow definition.

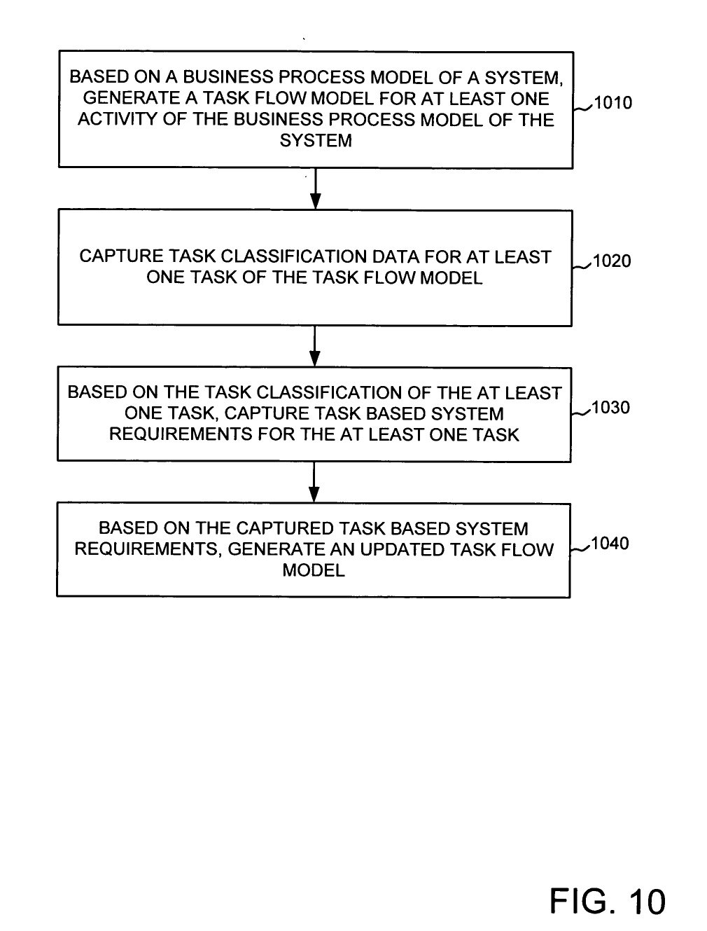

FIG. 10 describes one exemplary process implemented by the exemplary requirements engine 930 of FIG. 9 for capturing task based system requirements. At 1010, a task flow model (e.g., 400 of FIG. 4) is first built to represent the various functional requirements of at least one activity derived from a business process model of the system (e.g., 100 of FIG. 1). At 1020, at least some of the tasks in the task flow model are classified as interactive tasks involving interaction with a user task or a system task involving some work to be performed by the system, as described above. At 1030, based at least on the task classification, task based design requirements are captured. For instance, as described above, interactive tasks can have specified performance requirements, such as think time and response time (see, e.g., description above with respect to FIG. 7). An interactive task can also have one or more usability requirements specified such as related screens, which in conjunction with a flow of tasks can form a screen flow (e.g., see description above with respect to FIG. 6). Once, the appropriate requirements are elicited, the task flow model (e.g., 941 in FIG. 9) is updated at 1040 to reflect the addition of the more comprehensive set of requirements. The updated task flow model (e.g., 941 in FIG. 9) can be analyzed and otherwise used to generate reports 935 in FIG. 9.

### An Exemplary Method for Processing Security Requirements Data to Update a Task Flow Model of a System

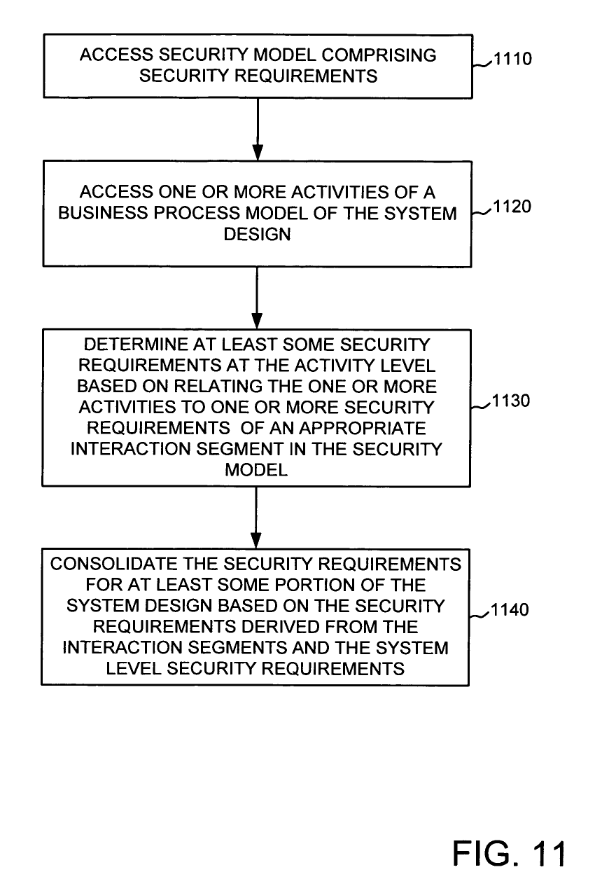

The software development tool 900 of FIG. 9 can be programmed to further have the capability of adding security related requirements, as described above, to update a task flow model 941 of a system, for instance. Security requirements of the individual systems may be influenced by not only the general security functional requirements that specify how sessions are managed and user data is protected, for instance, but also, the interaction security requirements that specify how interacting parties are identified, and/or authenticated. Thus, once a business process model of a proposed system (e.g., 100 of FIG. 1) is available and activities therein are identified, the security model 944 can be applied to the activities to determine the appropriate security requirements. The security model 944 of FIG. 9 comprises a collaboration model listing various segments outlining security relationships between various security entities. The exemplary requirements engine 930 desirably is further capable of accessing the security model at 1110 of FIG. 11. Then at 1120, least one activity related to the business process model is desirably accessed. Further at 1130, based on the type of activity, interaction segments in the security model are appropriately matched to the activities to derive at least some security requirements for the activity. Later at 1140, the activity level security requirements are consolidated with the system level security requirements. Thus, for instance, if system level requirements specify higher requirements for all logon activities, these requirements are desirably superimposed over any requirements defined at the activity level. In this manner, the security model 944 may be used to update the task flow model 941 with security related requirements.

### An Exemplary Process for Verifying Domain Context Quality of System Requirements

Task flow models 941 in FIG. 9, at various levels of detail provide an exemplary framework for specifying system requirements, both functional and non-functional. Each task in a task flow model can be designated to be associated with corresponding domains, each of which may have domain concepts associated therewith. These domain concepts are desirably stored with domain model 943. Based on the domain models they are associated with, the domain context quality of a selected task flow model can be evaluated based on the use of terms, norms, and rules of the domain used in the requirements, for instance.

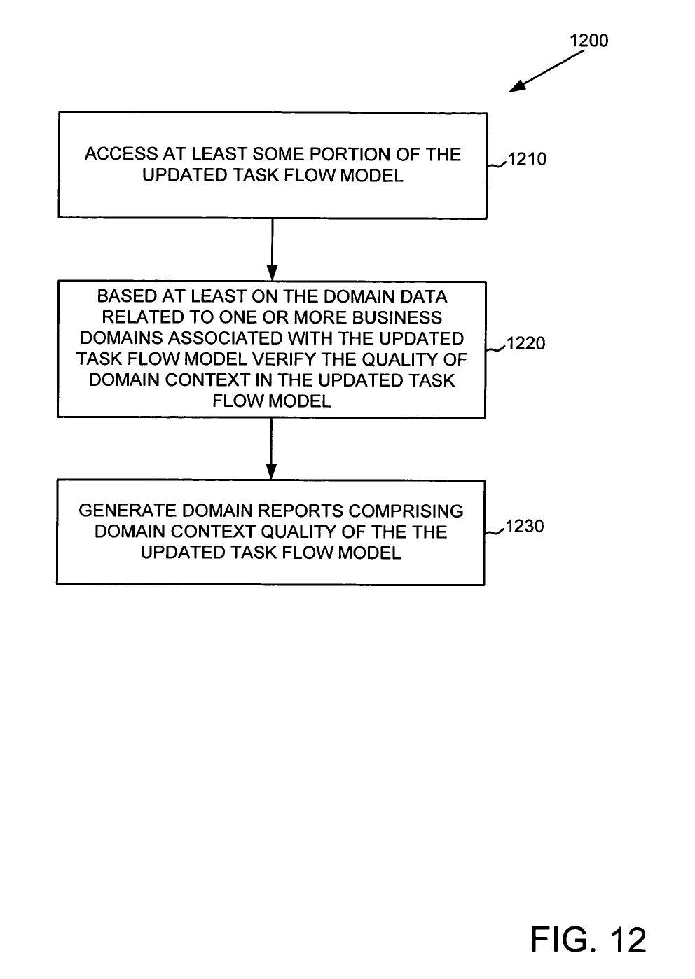

FIG. 12 illustrates an exemplary domain verification process 1200 for verifying the domain context quality of a task flow model updated with non-functional requirements. At 1210, a task flow model updated with non-functional requirements (e.g., performance, usability and security) is accessed. Then at 1220, desirably based at least on the domain model data (e.g., 943 in FIG. 9) the domain context quality of the updated task flow model 941 is evaluated. At 1230, the domain reports (e.g., 955 in FIG. 9) are generated for reporting, among other things, a quality value of the domain context of the updated task flow model. The quality value may be, for example, based on the frequency of occurrence of selected domain terms in the specified requirements. Re-use of consistent terms in describing functional requirements of a system improves the requirements document by reducing the chances of misunderstanding between various stakeholders contributing to the requirements specification process.

### Exemplary User Interfaces of a Software Development Tool for Specifying Requirements

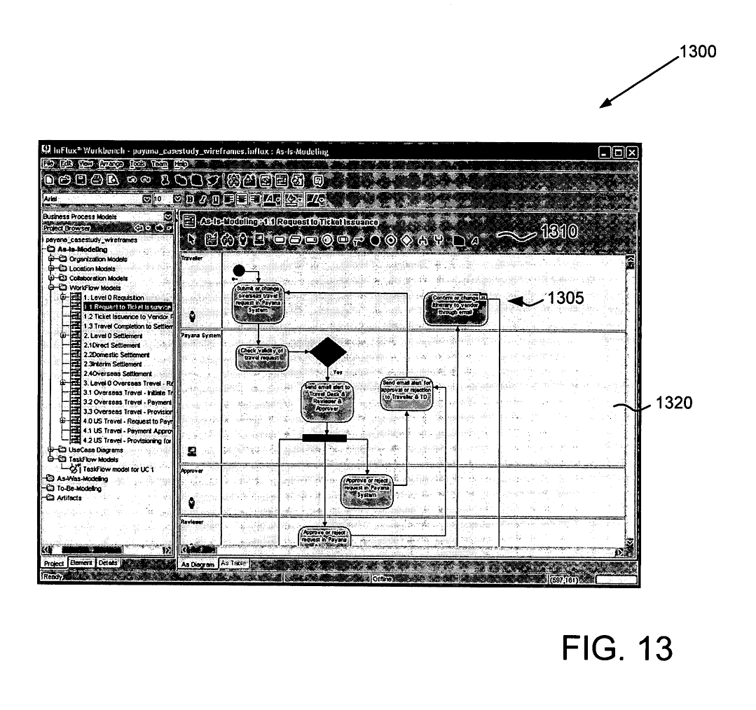

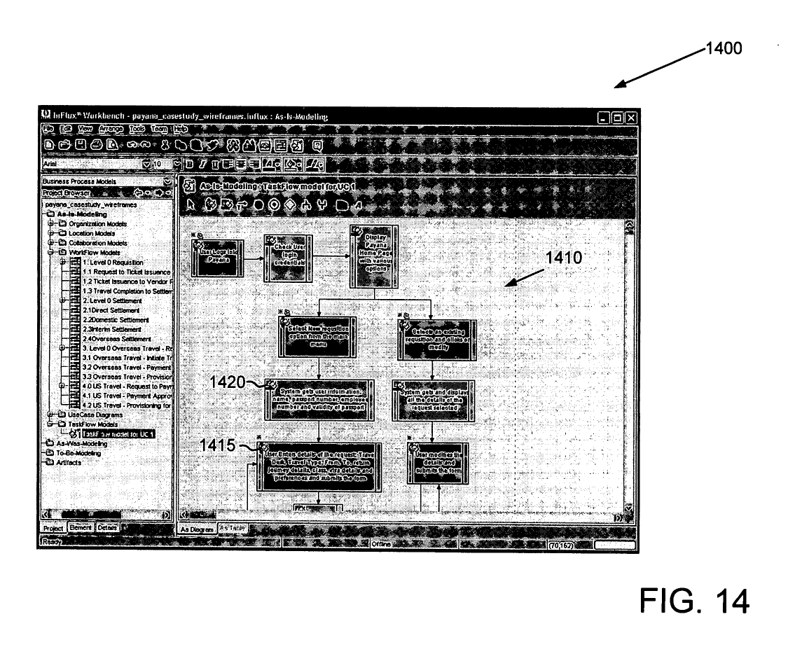

FIGS. 13-22 illustrate a set of exemplary user interfaces for the software development tool 900 of FIG. 9. FIG. 13 illustrates a user interface 1300 for building a business process model (e.g., 100 in FIG. 1). Among other things, the business process builder user interface 1300 comprises a tool bar 1310 comprising workflow icons for constructing the business process model 1305 by simply dragging and dropping onto the building panel 1320 and adding descriptive text thereon. FIG. 14 illustrates an exemplary task flow builder user interface 1400 for building a task flow model 1410. The exemplary task flow model 1410 relates to one of the activities of the business process model 1305. Classification of a task as an interactive task 1415 or a system task 1420 may be accomplished by annotating a selected task with the appropriate icon (e.g., see Table 1)

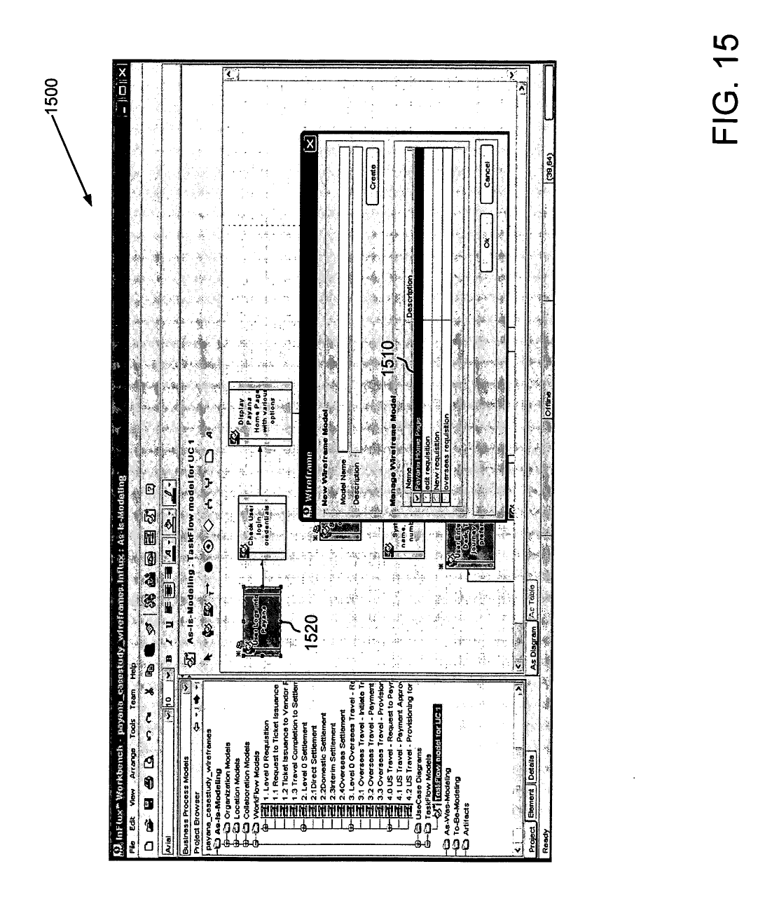

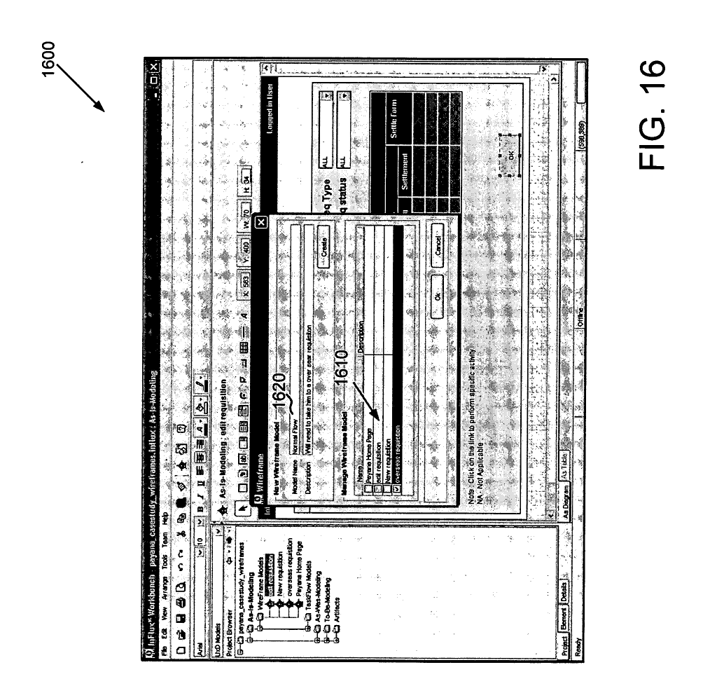

FIG. 15 illustrates an exemplary user interface 1500 for specifying at least some usability requirements for a task by associating a screen 1510 with a selected task 1520. FIG. 16 illustrates an exemplary user interface 1600 for connecting a set of screens 1610 together, at least some of which may have associations to appropriate tasks to form a screen flow. The software development tool is desirably capable of synthesizing the screen flow to simulate the navigation of the various screens associated with a particular task flow 1620.

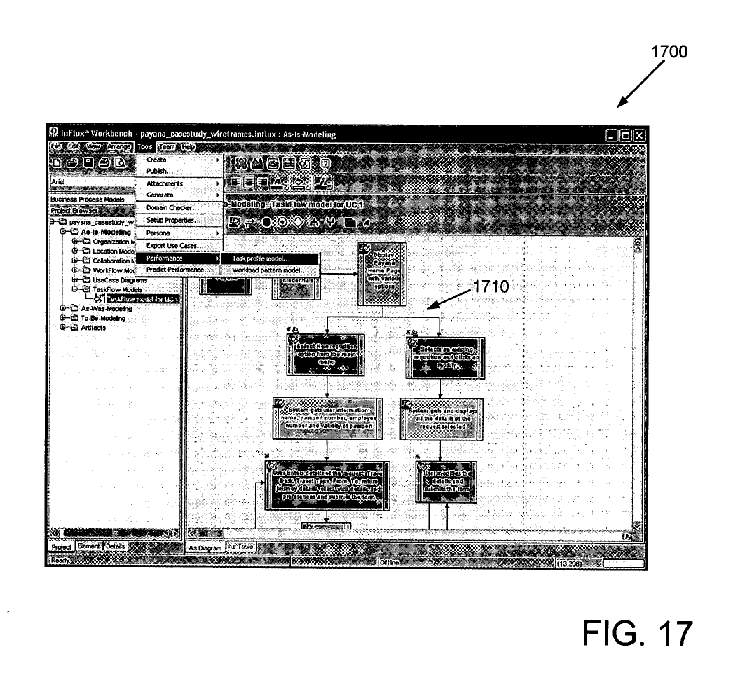

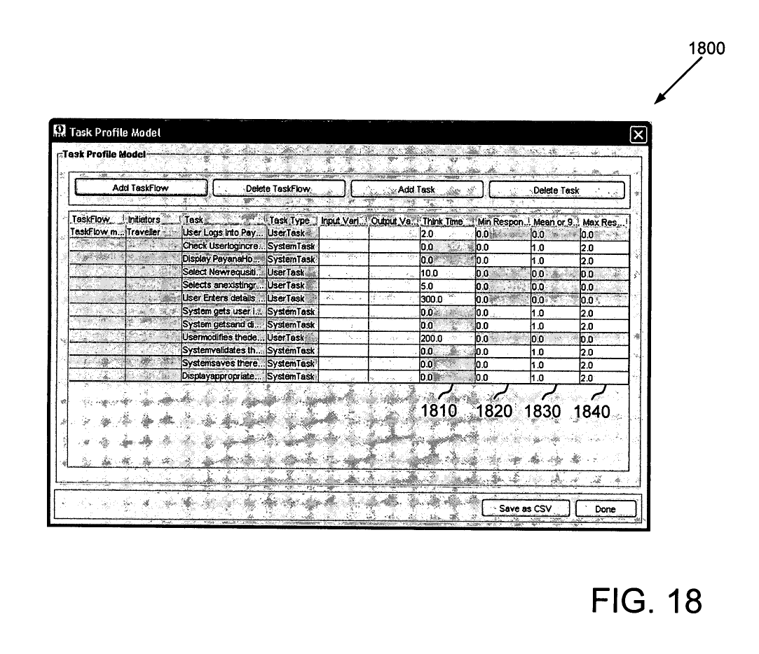

FIG. 17 illustrates an exemplary user interface 1700 for user selection of a task flow model 1710 for which the performance requirements are to be specified. FIG. 18 illustrates an exemplary user interface 1800 for specifying performance requirements. The user tasks or interactive tasks will desirably have a place for accepting think time entries 1810. Both the system tasks and the interactive tasks will desirably have a place for accepting response time entries in terms of a minimum 1820, a mean 1830 and a maximum response time 1840.

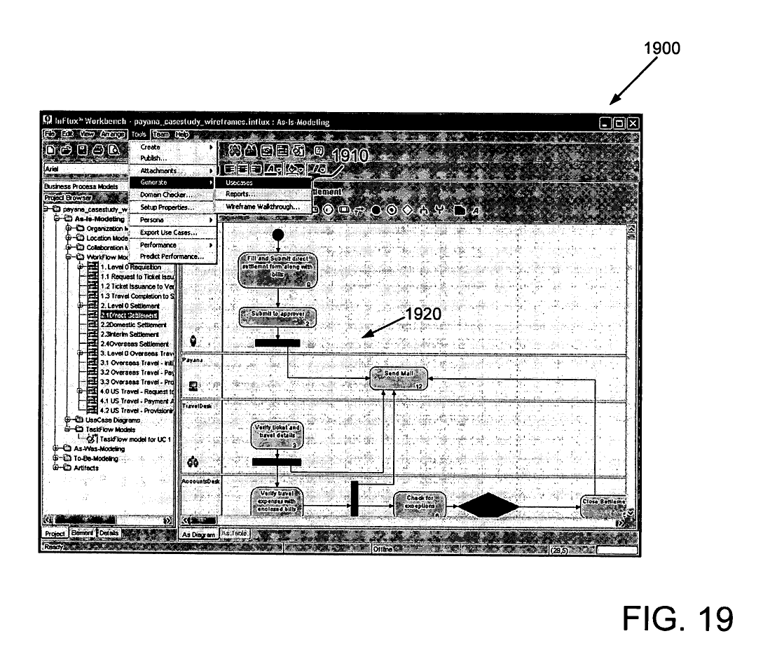

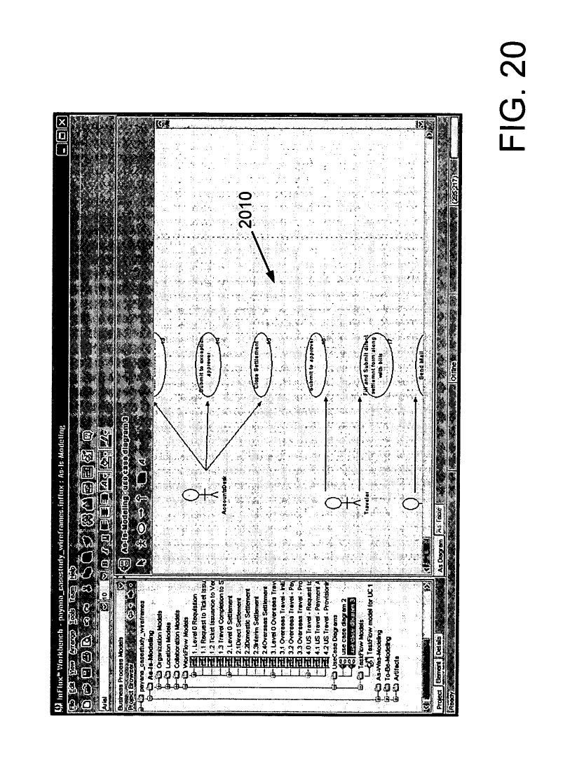

FIG. 19 illustrates an exemplary user interface 1900 for a user to request at 1910 a use case in UML form for a selected business process model 1920. The selection of the request 1910 causes the software tool 900 to convert the existing business model 1920 to a UML form use case, such as the example, at 2010 in FIG. 20.

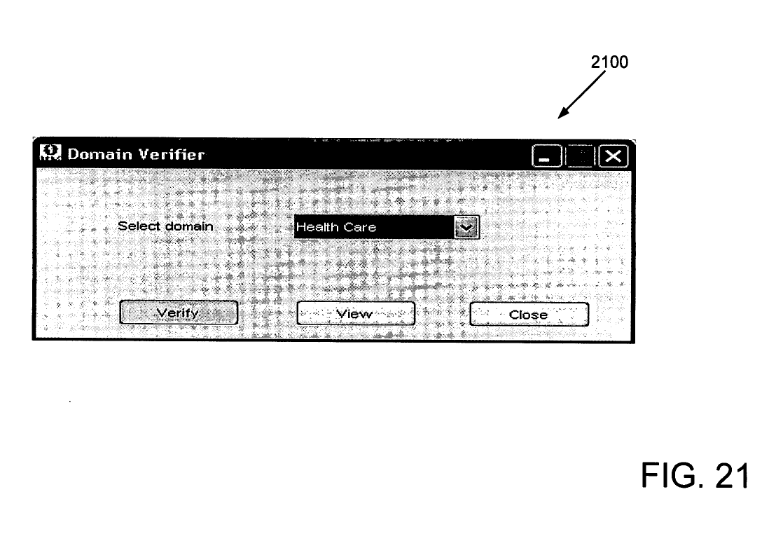

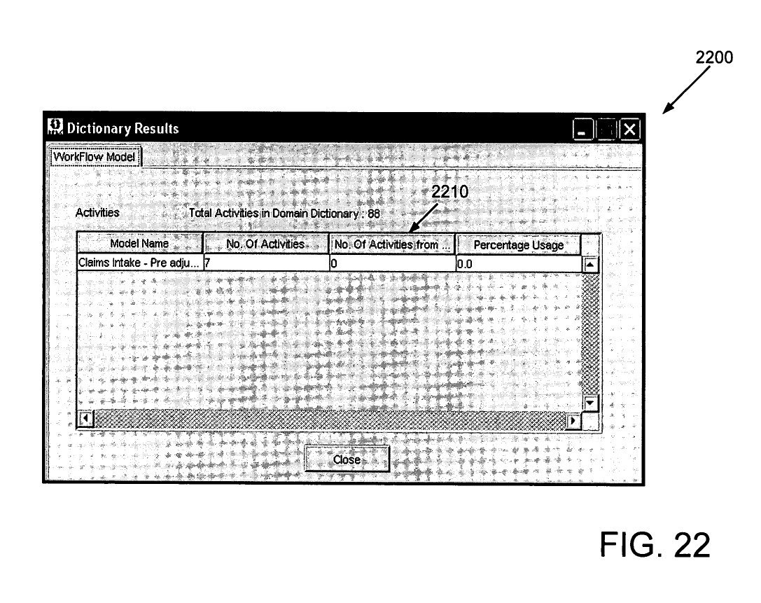

FIG. 21 illustrates an exemplary user interface 2100 for a user selection of a domain model against which the domain context quality of a selected requirements specification can be verified. FIG. 22 illustrates an exemplary user interface 2200 which comprises results 2210 of the domain verification process (e.g., 1200 of FIG. 12) as implemented by the domain verification engine 950, for instance.

### Exemplary Computing Environment

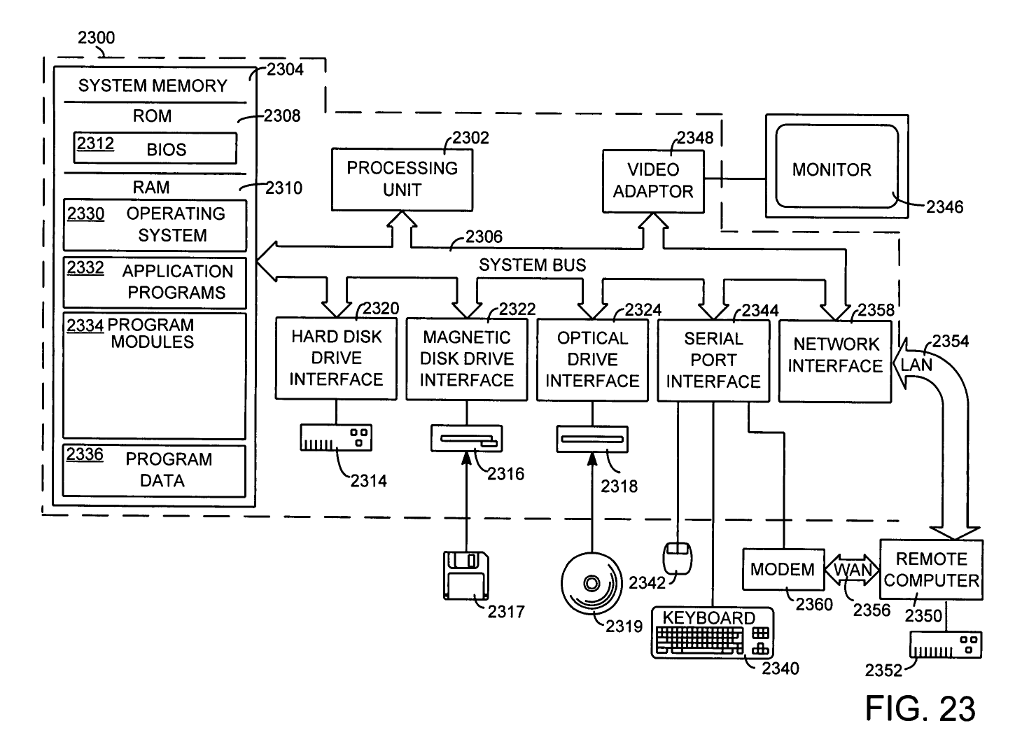

FIG. 23 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 23, an exemplary system for implementing the disclosed technology includes a general purpose computing device in the form of an exemplary conventional PC 2300, including a processing unit 2302, a system memory 2304, and a system bus 2306 that couples various system components including the system memory 2304 to the processing unit 2302. The system bus 2306 may be any of several types of bus structures including a memory bus or memory controller, a peripheral bus, and a local bus using any of a variety of bus architectures. The exemplary system memory 2304 includes read only memory (ROM) 2308 and random access memory (RAM) 2310. A basic input/output system (BIOS) 2312, containing the basic routines that help with the transfer of information between elements within the PC 2300, is stored in ROM 2308.

The exemplary PC 2300 further includes a hard disk drive 2314 for reading from and writing to a hard disk (not shown), a magnetic disk drive 2316 for reading from or writing to a removable magnetic disk 2317, and an optical disk drive 2318 for reading from or writing to a removable optical disk 2319 (such as a CD-ROM or other optical media). The hard disk drive 2314, magnetic disk drive 2316, and optical disk drive 2318 are connected to the system bus 2306 by a hard disk drive interface 2320, a magnetic disk drive interface 2322, and an optical drive interface 2324, respectively. The drives and their associated computer-readable media provide nonvolatile storage of computer-readable instructions, data structures, program modules, and other data for the PC 2300. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored on the hard disk 2314, magnetic disk 2317, optical disk 2319, ROM 2308, or RAM 2310, including an operating system 2330, one or more application programs 2332, other program modules 2334, and program data 2336. A user may enter commands and information into the PC 2300 through input devices such as a keyboard 2340 and pointing device 2342 (such as a mouse). Other input devices (not shown) may include a digital camera, microphone, joystick, game pad, satellite dish, scanner, or the like. These and other input devices are often connected to the processing unit 2302 through a serial port interface 2344 that is coupled to the system bus 2306, but may be connected by other interfaces such as a parallel port, game port, or universal serial bus (USB). A monitor 2346 or other type of display device is also connected to the system bus 2306 via an interface, such as a video adapter 2348. Other peripheral output devices, such as speakers and printers (not shown), may be included.

The PC 2300 may operate in a networked environment using logical connections to one or more remote computers, such as a remote computer 2350. The remote computer 2350 may be another PC, a server, a router, a network PC, or a peer device or other common network node, and typically includes many or all of the elements described above relative to the PC 2300, although only a memory storage device 2352 has been illustrated in FIG. 23. The logical connections depicted in FIG. 23 include a local area network (LAN) 2354 and a wide area network (WAN) 2356. Such networking environments are commonplace in offices, enterprise-wide computer networks, intranets, and the Internet.

When used in a LAN networking environment, the PC 2300 is connected to the LAN 2354 through a network interface 2358. When used in a WAN networking environment, the PC 2300 typically includes a modem 2360 or other means for establishing communications over the WAN 2356, such as the Internet. The modem 2360, which may be internal or external, is connected to the system bus 2306 via the serial port interface 2344. In a networked environment, program modules depicted relative to the personal computer 2300, or portions thereof, may be stored in the remote memory storage device. The network connections shown are exemplary, and other means of establishing a communications link between the computers may be used.

Having described and illustrated the principles of our invention with reference to the illustrated embodiments, it will be recognized that the illustrated embodiments can be modified in arrangement and detail without departing from such principles. For instance, elements of the illustrated embodiment shown in software may be implemented in hardware and vice-versa. Also, the technologies from any example can be combined with the technologies described in any one or more of the other examples. In view of the many possible embodiments to which the principles of the invention may be applied, it should be recognized that the illustrated embodiments are examples of the invention and should not be taken as a limitation on the scope of the invention. For instance, various components of systems and tools described herein may be combined in function and use. We therefore claim as our invention all subject matter that comes within the scope and spirit of these claims. Alternatives specifically addressed in these sections are merely exemplary and do not constitute all possible alternatives to the embodiments described herein.

We claim:

1. A software development tool for capturing requirements related to a proposed software system, the software development tool comprising:
a requirements capture user interface for capturing user input related to the software system; and
a requirements engine programmed for capturing user input related to a business process model of at least some portion of the software system, accessing at least one user selected activity of the business process model for generating one or more task flow builder screens of the requirements capture user interface for accepting user input related to building a task flow model of the at least one activity of the business process model and based on the user input related to building the task flow model, building the task flow model comprising at least some functional and non-functional requirements of the system.

2. The software development tool of claim 1, wherein the task flow model comprises one or more tasks related to the system and the functional requirements comprise at least some representation of one or more workflows between related tasks.

3. The software development tool of claim 1, wherein the task flow model comprises one or more tasks related to the system and the non-functional requirements comprise at least one requirement selected from a group consisting of usability, performance and security.

4. The software development tool of claim 3, wherein the requirements capture engine is further programmed for capturing user input related to a classification of the one or more tasks of the task flow model and based at least on the classification of the one or more tasks, capturing the appropriate non-functional requirements.

5. The software development tool of claim 4, wherein the classification of the one or more tasks comprises an interactive task classification and a system task classification.

6. The software development tool of claim 5, wherein the non-functional requirements related to the interactive task classification comprises a requirement selected from a group consisting of a think time, a screen and a response time.

7. The software development tool of claim 5, wherein the non-functional requirements related to a system task classification comprises a response time.

8. The software development tool of claim 1, further comprising a domain verification engine for verifying the domain context quality of the task flow model based on an appropriate domain model associated with the task flow model.

9. The software development tool of claim 1, wherein the non-functional requirements comprise security requirements and the requirements engine is further programmed to access a security model related to the system and based on the security model, determining security requirements for the at least one activity of the business process model of the system.

10. The software development tool of claim 9, wherein determining security requirements for the at least one activity of the business process model of the system design comprises relating the at least one activity to a corresponding interaction segment in the security model and deriving security requirements for the at least one activity based on the security requirements related to the interaction segment.

11. The software development tool of claim 10, wherein determining security requirements for the at least one activity of the business process model of the system design further comprises consolidating the security requirements derived for the at least one activity from the related interaction segment with system level security requirements in the security model.

12. A computer implemented method of capturing requirements of a proposed software system, the method comprising:
based on a user selection of at least one activity of a business process model of the software system, present one or more task flow builder screens for accepting user input related to building a task flow model comprising one or more tasks representing at least a portion of the software system, wherein the user input related to building the task flow model comprises at least some functional and non-functional requirements of the software system; and
based on the at least some of the functional and non-functional requirements, generating a representation of the task flow model of the software system comprising the functional and non-functional requirements.

13. The method claim 12, wherein the functional requirements are represented in the task flow model in terms of workflow notations associating the one or more tasks of the task flow model.

14. The method of claim 12, wherein the non-functional requirements comprise one or more requirements selected from a group consisting of performance requirements, usability requirements and security requirements.

15. The method of claim 12, wherein at least some of the non-functional requirements for generating the task flow model are based at least in part on a task classification of at least one of the one or more tasks of the task flow model.

16. The method of claim 15, wherein the task classification of the at least one of the one or more tasks is as a system task and the non-functional requirement related to the system task comprises response time.

17. The method of claim 15, wherein the task classification of the at least one task of the one or more tasks of the task flow model is as a interactive task and the non-functional requirements related to the interactive task comprises at least one requirement selected from a group consisting of usability requirements, response time and think time.

18. The method of claim 17, wherein the usability requirements comprise a specification of a user interface screen corresponding to the at least one task of the one or more tasks of the task flow model.

19. The method of claim 18, further comprising capturing flow of screens corresponding to the task flow model for simulating the usability of the software system.

20. The method of claim 12, wherein the non-functional requirements comprise security requirements and generating the task flow model comprises adding security requirements to the task flow model by accessing a security model related to the system, matching at least one interaction segment of the security model to the at least one activity of the business process model to derive the security requirements related to the at least one activity.

21. The method of claim 20, further comprising consolidating the security requirements derived from the interaction segments of the security model with system level security requirements associated with the system.

22. At least one computer-readable medium having stored thereon computer-executable instructions for performing a method of capturing requirements of a proposed software system, the method comprising:
receiving a user selection of at least one activity of a business process model of the software system;
presenting one or more task flow builder screens for accepting user input related to building a task flow model comprising one or more tasks related to the at least one user selected activity of the business process model,
receiving the user input related to building the task flow model comprising at least some functional and non-functional requirements of the software system; and
based on the at least some of the functional and non-functional requirements, generating a representation of the task flow model of the software system comprising the functional and non-functional requirements.
